(19) United States
(12) Patent Application Publication
(10) Pub. No.: US 2024/0141176 A1
(43) Pub. Date: May 2, 2024

(54) LIGHT-SHIELDING FILM AND LIGHT-SHIELDING PAINT

(71) Applicant: CANON KABUSHIKI KAISHA, Tokyo (JP)

(72) Inventors: REIKO KUBOTA, Kanagawa (JP); YASUHIRO TANAKA, Tokyo (JP)

(21) Appl. No.: 18/497,738

(22) Filed: Oct. 30, 2023

(30) Foreign Application Priority Data
Oct. 31, 2022 (JP) 2022-174688

(51) Int. Cl. C09D 5/00; C09D 7/40; C09D 7/41; C09D 7/61; C09D 7/65; C09D 163/00; G02B 1/04

(52) U.S. Cl. CPC C09D 5/006; C09D 7/41; C09D 7/61; C09D 7/65; C09D 7/67; C09D 7/68; C09D 163/00; G02B 1/04; G02B 5/003

(57) ABSTRACT

A light-shielding film comprising a resin, an inorganic particle and an organic particle, wherein the organic particle is a core-shell particle which has a surface layer portion and a center portion, and an elastic modulus of the surface layer portion is higher than an elastic modulus of the center portion.

### BACKGROUND

### Field of the Disclosure

The present disclosure relates to a light-shielding film and a light-shielding paint.

### Description of the Related Art

The light-shielding film is a film formed on the surface of a substrate made of glass, plastic or the like, which is a main component of an optical element. Providing the light-shielding film enables to reduce the reflected light from the inner surface which adversely affects the image to suppress the flare and the ghost.

In recent years, the joining portion of the cemented lens or the lens edge surface has become thinner and soft glass has increasingly used for the lens. Accordingly, when the light-shielding film is formed on the outer peripheral portion of the lens, the lens tends to be stressed. In addition, the lens is often used in situations where large thermal shock is applied, such as in a cold-temperature or scorching-temperature environment. Therefore, it is required to reduce stress on the lens caused by the light-shielding film.

Further, it is preferable that the lens is cleaned by ultrasonic waves multiple times after forming a light-shielding film in order to remove very fine dirt adhered to the lens generated in the manufacturing process of the lens. The light-shielding film is required to have washability without causing peeling at the interface with the lens due to ultrasonic vibration during cleaning.

Japanese Patent Application Laid-Open No. 2015-158544 discloses the light-shielding film in which the organic particles such as rubber particles are added as fine particles each having a film elastic modulus of 0.01 GPa or more and 7 GPa or less in order to suppress bubble and film cracking at the interface.

As described in Japanese Patent Application Laid-Open No. 2015-158544, when the fine particles each having a low elastic modulus such as rubber particles are added to the light-shielding film, stress on the glass is reduced, but further improvement of washability of the light-shielding film is required.

### SUMMARY

The present disclosure is made in view of such background technology and an object of the present disclosure is to provide the light-shielding film which prevents cracking of the lens even when the lens configuration is easily subjected to stress and the lens is exposed to severe thermal shock, has high washability, and has high anti-internal reflection performance.

The light-shielding film of the present disclosure is a light-shielding film comprising a resin, an inorganic particle and an organic particle, wherein the organic particle is a core-shell particle which has a surface layer portion and a center portion, and an elastic modulus of the surface layer portion is higher than an elastic modulus of the center portion.

The light-shielding paint of the present disclosure is a light-shielding paint comprising a resin, an inorganic particle and an organic particle, wherein the organic particle is a core-shell particle which has a surface layer portion and a center portion, and an elastic modulus of the surface layer portion is higher than an elastic modulus of the center portion.

The light-shielding paint of the present disclosure is a light-shielding paint comprising a mixture of an agent A of black color containing at least an inorganic particle and a solvent, an agent B containing at least a resin and an organic particle, and an agent C containing at least a curing agent and a curing agent accelerator, wherein the organic particle is a core-shell particle which has a surface layer portion and a center portion, and an elastic modulus of the surface layer portion is higher than an elastic modulus of the center portion.

Further features of the present disclosure will become apparent from the following description of exemplary embodiments with reference to the attached drawings.

### BRIEF DESCRIPTION OF THE DRAWINGS

FIG. 1 is a schematic sectional view for illustrating an example of the optical element in the present disclosure.

FIG. 2 is a schematic sectional view for illustrating the state of the interface between the light-shielding film and the lens.

FIG. 3A is a schematic sectional view for illustrating an interface between the light-shielding film containing single layer particles as the organic particles, and a lens.

FIG. 3B is a schematic sectional view for illustrating an interface between the light-shielding film containing core-shell particles as the organic particles, and a lens.

FIG. 4 is a schematic view for illustrating a method of measuring the ratio of the internal reflection of the light.

FIG. 5 is a schematic sectional view for illustrating the test piece used for the evaluation of thermal shock resistance.

FIG. 6 is a schematic sectional view for illustrating an example of a cemented lens which is the optical element in the present disclosure.

FIG. 7 is a schematic sectional view for illustrating an image pickup apparatus using a cemented lens in the present disclosure.

### DESCRIPTION OF THE EMBODIMENTS

An exemplary embodiment of the present disclosure will be described below.

[Role of the Light-Shielding Film]

The light-shielding film is a film formed on the surface of a substrate made of glass, plastic or the like, which is a main component of an optical element. The substrate may be a lens or a prism, or may be any other optical glass or an optical prism.

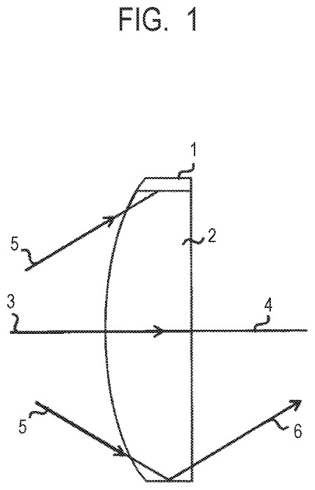

First, the role of the light-shielding film for the optical element will be described with reference to the drawings. FIG. 1 is a schematic sectional view for illustrating an example of the optical element in the present disclosure. As illustrated in FIG. 1, a light-shielding film 1 is formed on a freely-selected part of the outer peripheral portion which is outside the effective optical surface of the lens as a substrate 2. The light-shielding film 1 is preferably formed on all of the outer peripheral portion of the substrate 2, despite the light-shielding film 1 is not formed on a part of the outer peripheral portion in FIG. 1 for convenience of explanation.

Of the light incident on the substrate 2, the light (incident light 3) that does not reach the outer peripheral portion of the substrate 2 is transmitted as the transmitted light 4. On the other hand, of the light incident on the substrate 2, the light (incident light 5) that reaches the outer peripheral portion of the substrate 2 reaches the light-shielding film 1 provided on the outer peripheral portion of the substrate 2. In the part where the light-shielding film 1 is not formed, the light that reaches the outer peripheral portion of the substrate 2 is reflected from the inner surface and goes out of the substrate 2 as a reflected light 6 from the inner surface which is irrelevant to the image. The reflected light 6 from the inner surface causes flare, ghost or the like which deteriorates the quality of the image. Therefore, it is preferable to provide the light-shielding film 1 on the outer peripheral portion of the substrate 2 in order to prevent generation of the flare, the ghost, or the like. Providing the light-shielding film 1 reduces the reflected light 6 from the inner surface which adversely affects the image to prevent the flare and the ghost.

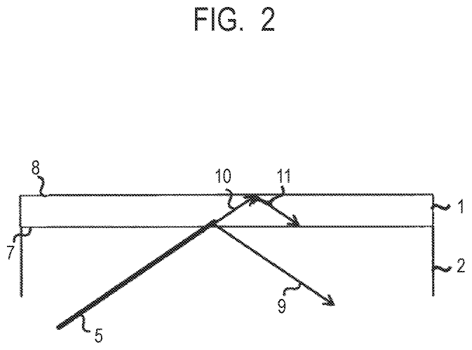

The reason why the internal reflection of the light is decreased by using this configuration is described below in detail. FIG. 2 is a schematic sectional view for illustrating the state of the interface between the light-shielding film and the substrate, in the substrate on which the light-shielding film is formed. FIG. 2 is also a schematic view for illustrating the traveling direction of the reflected light from the inner surface. FIG. 2 is a view for illustrating a state in which the light-shielding film 1 is applied to the surface of the outer peripheral portion of the substrate 2. As illustrated in FIG. 2, the internal reflection of the light mostly occurs at two interfaces: the interface (interface 7) between the substrate 2 and the light-shielding film 1 and the interface (interface 8) between the light-shielding film 1 and air. That is, when the incident light 5 passing through inside the substrate 2 reaches the interface 7, the incident light 5 is divided into the light (first reflected light 9) reflected from the interface 7 and the light (transmitted light 10) transmitted through the light-shielding film 1. The transmitted light 10 is reflected from the interface 8. The reflected light at this time becomes the second reflected light 11.

The first reflected light 9 can be reduced by making the refractive index of the light-shielding film 1 closer to the refractive index of the substrate 2 or by making the refractive index of the light-shielding film 1 higher than the refractive index of the substrate 2. As the refractive index of the substrate 2 increases, it is required that the refractive index of the light-shielding film 1 also increases. In addition, the second reflected light 11 can be reduced by absorbing the transmitted light 10. A colorant or the like is used to efficiently absorb the transmitted light 10 transmitted through the light-shielding film 1.

[Features of the Present Disclosure]

In order to suppress the internal reflection of the light, it is preferable to make the refractive index of the light-shielding film equal to or higher than the refractive index of the lens. In order to greatly increase the refractive index, it is preferable to add a large number of inorganic fine particles each having high refractive index nano-dispersed in a resin. However, since inorganic fine particles each have a high elastic modulus in general, when a large amount of inorganic fine particles are added, the film itself tends to become hard and cause much stress on the lens.

As a result of intensive studies made by the inventors of the present disclosure on a method for achieving all of high thermal shock resistance, high washability, and high anti-internal reflection performance, the inventors have found that they can be achieved by adding a core-shell particle having a surface layer portion and a center portion, and the elastic modulus of the surface layer portion is higher than the elastic modulus of the center portion.

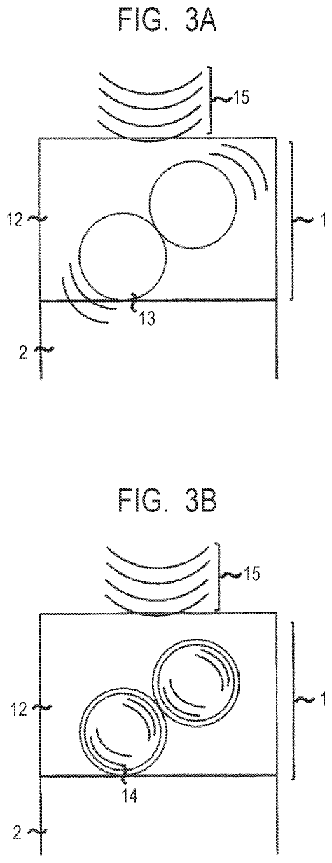

FIGS. 3A and 3B are schematic sectional views for each illustrating an interface between the light-shielding film containing the organic particles and a lens. The light-shielding film 1 in FIG. 3A contains single layer particles 13 as the organic particles. The light-shielding film 1 in FIG. 3B contains core-shell particles 14 as the organic particles, and the core-shell particles 14 each have a surface layer portion and a center portion, and the elastic modulus of the surface layer portion is higher than the elastic modulus of the center portion.

In general, the organic particles such as rubber particles capable of absorbing stress are used to improve thermal shock resistance. However, in the case of the optical element, in addition to thermal shock resistance, high washability is also required because the optical element is subjected to cleaning by ultrasonic waves in water to remove very fine dirt on the lens. As illustrated in FIG. 3A, when the light-shielding film 1 which is made flexible by adding the single layer particles 13 as the organic particles into a resin matrix 12 thereof is cleaned by ultrasonic waves, the single layer particles 13 in contact with each other, for example, by aggregation, cause ultrasonic vibration 15 to more easily reach to the interface between the light-shielding film 1 and a lens 2. In addition, at the point where the single layer particles 13 and the interface of the lens 2 are in contact, the ultrasonic vibration 15 of the single layer particles 13 caused by ultrasonic cleaning more easily propagates, and peeling is more likely to occur at the interface.

On the other hand, as illustrated in FIG. 3B, in the light-shielding film 1 which is made flexible by adding the core-shell particles 14 as the organic particles into a resin matrix 12 thereof, the elastic modulus of the surface layer portion of each of the core-shell particles 14 is higher than the elastic modulus of the center portion thereof, and the center portion has a low elastic modulus. Therefore, stress is less likely to accumulate even in the low temperature region where the elastic modulus becomes high. In addition, even when ultrasonic cleaning is performed multiple times to remove fine dirt on the lens, the shell (surface layer portion) becomes a partition wall to interrupt propagation of the ultrasonic vibration 15, and furthermore, the shell becomes a partition wall to prevent the center portion from coming into contact with the interface of the lens 2. Accordingly, even when ultrasonic cleaning is performed multiple times, the light-shielding film 1 is less likely to be peeled off.

[Light-Shielding Paint]

The light-shielding paint of the present disclosure is a light-shielding paint of black color containing at least a resin, an inorganic particle and an organic particle, wherein the organic particle is a core-shell particle which has a surface layer portion and a center portion, and the elastic modulus of the surface layer portion is higher than the elastic modulus of the center portion. The light-shielding paint of the present disclosure may be a light-shielding paint comprising a mixture of an agent A of black color containing at least an inorganic particle and a solvent, an agent B containing at least a resin and an organic particle, and an agent C containing at least a curing agent and a curing agent accelerator for the purpose of long-term preservation of the paint. The material composition and the producing method of the light-shielding paint according to the present disclosure will be described below.

The color of the light-shielding paint according to the present disclosure is black from the viewpoint of visible light absorption. In the present disclosure, the lightness (L) of the black color is preferably less than 14, more preferably 10 or less, and even more preferably 5 or less.

The cured film (light-shielding film) obtained by curing the light-shielding paint of the present disclosure preferably has the elastic modulus at −30° C. of 2,500 MPa or more and 3,800 MPa or less and the elastic modulus at 20° C. of 500 MPa or more and 2,600 MPa or less, as will be described later.

<<Material Composition>>

(Resin)

Any material can be used as the resin as long as the material is the resin that can form a light-shielding film. Examples of the resin include an epoxy resin, an acrylic resin, a urethane resin, an acrylic urethane resin, a phenol resin, a melamine resin, a polyester resin, an alkyd resin, and a polyimide resin.

The content of the resin is preferably 5 mass % or more and 80 mass % or less, and more preferably 8 mass % or more and 50 mass % or less with respect to the non-volatile content (solid content). When the content of the resin is less than 5 mass %, the light-shielding film may become too hard, resulting in film cracking. When the content of the resin is more than 80 mass %, it may be difficult to increase the refractive index of the film.

In the present disclosure, the non-volatile content (solid content) refers to the residue obtained when the light-shielding paint is held at 200° C. for 2 hours. Accordingly, the concentration in the light-shielding film is almost equal to the concentration with respect to the resin composition of the light-shielding paint containing the resin, the inorganic particles, the organic particles, and the like, excluding the organic solvent.

(Inorganic Particle)

The inorganic particles are contained in the light-shielding paint in the following state: a part of the inorganic particles is in a state where the primary particles of the inorganic particles are aggregated (present as an aggregate). The average particle diameter of the aggregates of the inorganic particles is preferably 2 nm or more and 250 nm or less, more preferably 50 nm or more and 200 nm or less, and even more preferably 100 nm or more and 180 nm or less. When the average particle diameter of the aggregates of the inorganic particles is more than 250 nm, scattered light on the light-shielding film may increase and poor appearance may be exhibited. When the average particle diameter of the aggregates of the inorganic particles is less than 2 nm, the paint may be thickened and coating property thereof may become insufficient.

The average particle diameter of the aggregates of the inorganic particles in the light-shielding film can be measured with a transmission electron microscopy (TEM). Specifically, after the light-shielding paint is cured to form the film, a cross section of the film is cut out and an image thereof is obtained with TEM. The image is analyzed by Image J to calculate the particle size distribution. To measure the particle diameter, 10 or more particles (aggregates) are placed in the evaluation screen, and the average diameter thereof is calculated. In addition, the average particle diameter of the aggregates of the inorganic particles in the light-shielding paint can be obtained from the peak value in the number-based particle size distribution obtained by the dynamic light scattering method.

The d-line refractive index of the inorganic particle is preferably 1.6 or more and 3.1 or less, and more preferably 2.0 or more and 3.1 or less. When the d-line refractive index thereof is less than 1.6, it is necessary to add a large number of the particles into the light-shielding film to increase the refractive index of the light-shielding film. Accordingly, the elastic modulus of the light-shielding film may become high and thermal shock resistance of the light-shielding film may become insufficient.

As the inorganic particle, a particle of any metal, metal oxide, metal nitride, metal fluoride, diamond, silicon, or the like may be used. Examples of the inorganic particle include bengala (d-line refractive index: 3.01), magnetite (d-line refractive index: 2.42), rutile-type titanium oxide (d-line refractive index: 2.72), anatase-type titanium oxide (d-line refractive index: 2.52), zirconium oxide (d-line refractive index: 2.05), cerium oxide (d-line refractive index: 2.2), zinc oxide (d-line refractive index: 2.1), tantalum pentoxide (d-line refractive index: 2.16), aluminum nitride (d-line refractive index: 1.9-2.2), tungsten oxide (d-line refractive index: 2.2), niobium pentoxide (d-line refractive index: 2.33), indium tin oxide (d-line refractive index: 2.06), chromium oxide (d-line refractive index: 2.24), diamond (d-line refractive index: 2.42), aluminium oxide (d-line refractive index: 1.63), cerium fluoride (d-line refractive index: 1.63), yttrium oxide (d-line refractive index: 1.87), magnesium oxide (d-line refractive index: 1.74), hafnium oxide (d-line refractive index: 1.95), lanthanum oxide (d-line refractive index: 1.84), scandium oxide (d-line refractive index: 1.89), europium oxide (d-line refractive index: 1.90), molybdenum oxide (d-line refractive index: 1.90), samarium fluoride (d-line refractive index: 1.90), praseodymium oxide (d-line refractive index: 1.92), silicon (d-line refractive index: 3.4), and zirconium nitride (d-line refractive index: 2.05).

Examples of titanium oxide include TTO-51 (A) (Ishihara Sangyo Kaisha, Ltd.), TTO-51 (C) (Ishihara Sangyo Kaisha, Ltd.), TTO-55 (A) (Ishihara Sangyo Kaisha, Ltd.), TTO-55 (B) (Ishihara Sangyo Kaisha, Ltd.), TTO-55 (C) (Ishihara Sangyo Kaisha, Ltd.), TTO-55 (D) (Ishihara Sangyo Kaisha, Ltd.), STR-100N (Sakai Chemical Industry Co., Ltd.), STR-100A-LP (Sakai Chemical Industry Co., Ltd.), STR-100C-LP (Sakai Chemical Industry Co., Ltd.), STR-100W-LP (Sakai Chemical Industry Co., Ltd.), STR-100C-LF (Sakai Chemical Industry Co., Ltd.), STR-100W-OTS (Sakai Chemical Industry Co., Ltd.), STR-100W(G) (Sakai Chemical Industry Co., Ltd.), STR-400TS (Sakai Chemical Industry Co., Ltd.), MT-01 (Tayca Corporation), MT-10EX (Tayca Corporation), MT-05 (Tayca Corporation), MT-100S (Tayca Corporation), MT-100TV (Tayca Corporation), MT-100Z (Tayca Corporation), MT-150EX (Tayca Corporation), MT-150 W (Tayca Corporation), MT-100AQ (Tayca Corporation), MT-100WP (Tayca Corporation), MT-100SA (Tayca Corporation), MT-100HD (Tayca Corporation).

These inorganic particles may be used alone or as a composite containing a plurality of kinds thereof.

The shape of the inorganic particle may be any shape. Examples of the shape of the inorganic particle include a spherical shape, an amorphous shape, a plate-like shape, a needle-like shape, a star-like shape, a chain-like shape, a multi-layered structure in which plate-like particles are laminated. In addition, the inorganic particle may be coated with another material. Further, the shapes of the inorganic particles may be one type or may include multiple types.

The content of the inorganic particle is preferably 2 mass % or more and 60 mass % or less, more preferably 5 mass % or more and 30 mass % or less with respect to the non-volatile content (solid content). When the content of the inorganic particle is less than 2 mass %, the refractive index of the light-shielding film does not increase significantly, and anti-internal reflection performance thereof may become insufficient. In addition, when the content of the inorganic particle is more than 60 mass %, the elastic modulus of the light-shielding film becomes too high, and even when the organic particle (core-shell particle) described later is added, thermal shock resistance of the film may not be improved.

(Organic Particle)

The organic particle is a core-shell particle which has a surface layer portion and a center portion, and the elastic modulus of the surface layer portion is higher than the elastic modulus of the center portion. When the light-shielding film does not include the organic particle, thermal shock resistance thereof may deteriorate. In addition, when the organic particle has no surface layer portion, washability of the light-shielding film deteriorates.

First, the surface layer portion of the organic particle will be described. The surface layer portion may have a single layer or a plurality of layers, and the material concentration or hardness thereof may be gradient. The surface layer portion is harder than the center portion. When the surface layer portion is softer than the center portion, the light-shielding film is likely to be peeled off during cleaning by ultrasonic waves. The surface layer portion preferably has the elastic modulus of 500 MPa or more and 10,000 MPa or less, and more preferably has the elastic modulus of 1,000 MPa or more and 5,000 MPa or less. In addition, the elastic modulus of the surface layer portion is preferably 5 times or more and 1,000 times or less the elastic modulus of the center portion, and more preferably 10 times or more and 300 times or less the elastic modulus of the center portion. A part of the surface layer portion may contain an inorganic material. Any material may be selected for the surface layer portion as long as the elastic modulus thereof is higher than that of the center portion. Examples of the material for the surface layer portion include an epoxy resin, an acrylic resin, a urethane resin, an acrylic urethane resin, a phenol resin, a melamine resin, a polyester resin, an alkyd resin, a polyimide resin, and combination therefrom. The thickness of the surface layer portion is preferably 0.1 nm or more and 50 nm or less, and more preferably 1 nm or more and 20 nm or less. When the thickness of the surface layer portion is less than 0.1 nm, washability of the light-shielding film may become insufficient. When the thickness of the surface layer portion is more than 50 nm, the film may become hard and thermal shock resistance of the film may become insufficient.

Next, the center portion of the organic particle will be described. The elastic modulus of the center portion is lower than the elastic modulus of the surface layer portion. When the elastic modulus of the center portion is equal to or higher than that of the surface layer portion, thermal shock resistance of the light-shielding film deteriorates. The elastic modulus of the center portion is preferably 0.1 MPa or more and 1,000 MPa or less, and more preferably 1 MPa or more and 500 MPa or less. It is technically difficult to make the elastic modulus of the center portion less than 0.1 MPa. When the elastic modulus of the center portion is more than 1,000 MPa, thermal shock resistance of the light-shielding film may become insufficient.

For the center portion, any material may be selected as long as the elastic modulus thereof is lower than that of the surface layer portion, and the center portion preferably contains rubber. Examples of the material for the center portion include acrylic rubber, urethane rubber, silicone rubber, butadiene rubber, nitrile rubber, fluororubber, isoprene rubber, styrene rubber, natural rubber, butyl rubber, ethylene propylene rubber, chloroprene rubber, hypal on, chlorinated polyethylene rubber, epichlorohydrin rubber, polysulfide rubber, and the like. The diameter of the center portion is preferably 1 nm or more and 200 nm or less, and more preferably 10 nm or more and 150 nm or less. When the diameter of the center portion is less than 1 nm, washability of the light-shielding film may become insufficient. When the diameter of the center portion is more than 200 nm, anti-internal reflection performance of the light-shielding film may become insufficient.

The primary particles of the organic particles preferably have the average particle diameter of 50 nm or more and 200 nm or less, and more preferably have the average particle diameter of 60 nm or more and 180 nm or less. The average particle diameter of the primary particles of the organic particles can be determined in the same manner as the average particle diameter of the aggregates of the inorganic particles. When the average particle diameter of the primary particles of the organic particles is less than 50 nm, thermal shock resistance of the light-shielding film may become insufficient. In addition, when the average particle diameter of the primary particles of the organic particles is more than 200 nm, scattered light on the light-shielding film may increase and washability of the light-shielding film may become insufficient. The shapes of the organic particles may be any shape. Examples of the shape of the organic particle include a spherical shape, an oval shape, a cuboid shape, a plate-like shape, an irregular shape, a star-like shape, a spindle shape, a needle-like shape.

The content of the organic particle is preferably 1 mass % or more and 50 mass % or less, and more preferably 2 mass % or more and 20 mass % or less with respect to the non-volatile content (solid content). When the content of the organic particle is less than 1 mass %, the elastic modulus at the low temperature of the light-shielding film does not become sufficiently low and thermal shock resistance of the film may become insufficient. When the content of the organic particle is more than 50 mass %, washability of the film may become insufficient.

(Curing Agent)

The light-shielding paint may contain a curing agent. Any material can be used as the curing agent as long as the material can react with a resin to cure. Examples of the curing agent include an amine-based curing agent, an isocyanate-based curing agent, and a photoinitiator.

Examples of the amine-based curing agent include Adeka Hardener EH-6019 (Adeka Corporation), Adeka Hardener EH-6024 (Adeka Corporation), Adeka Hardener EH-6028 (Adeka Corporation), Adeka Hardener EH-479 (Adeka Corporation), Adeka Hardener EH-451N (Adeka Corporation), Adeka Hardener EH-4602 (Adeka Corporation), Adeka Hardener EH2300 (Adeka Corporation), Adeka Hardener EH3427A (Adeka Corporation), Adeka Hardener EH-4024W (Adeka Corporation), ST11 (Mitsubishi Chemical Corporation), ST12 (Mitsubishi Chemical Corporation), ST14 (Mitsubishi Chemical Corporation), ST15 (Mitsubishi Chemical Corporation), H3 (Mitsubishi Chemical Corporation), H30 (Mitsubishi Chemical Corporation), FL11 (Mitsubishi Chemical Corporation), FL11W (Mitsubishi Chemical Corporation), SA1 (Mitsubishi Chemical Corporation).

The content of the curing agent is preferably 1 mass % or more and 50 mass % or less, more preferably 5 mass % or more and 40 mass % or less, with respect to the non-volatile content (solid content). When the content of the curing agent is less than 1 mass %, the curing property may become insufficient and washability of the light-shielding film may become insufficient. When the content of the curing agent is more than 50 mass %, anti-internal reflection performance of the light-shielding film may become insufficient.

(Curing Agent Accelerator)

The light-shielding paint may include a curing agent accelerator. When the optical element is cured at a high temperature, distortion may occur in the lens, and lens property may be adversely affected. Accordingly, the optical element is preferably cured at a low temperature, that is, any temperature from normal temperature to 120° C. When the curing agent accelerator is added to the paint, it takes shorter time to cure the paint than when only a curing agent is added thereto. In addition, by adding the curing agent accelerator to the paint, the elastic modulus of the light-shielding film can be increased even when the film is cured at a low temperature, and peeling of the film caused by cleaning can be suppressed even when the film is subjected to ultrasonic cleaning immediately after curing.

Any material can be used as the curing agent accelerator as long as the material can accelerate the reaction of the curing agent. Examples of the curing agent accelerator include N, N-dimethylbenzylamine, salicylic acid, and 2,4,6-tris (dimethylamino) phenol. These materials are may be used alone or in combination of two or more kinds thereof.

The content of the curing agent accelerator is preferably 0.01 mass % or more and 5 mass % or less, and more preferably 0.1 mass % or more and 1 mass % or less with respect to the non-volatile content (solid content). When the content of the curing agent accelerator is less than 0.01 mass %, it may take a long time to cure the paint. When the content of the curing agent accelerator is more than 5 mass %, optical properties may become insufficient.

(Solvent)

The light-shielding paint may contain a solvent. Any material may be used as the solvent. It is not necessary to add a solvent to the paint when the light-shielding paint has a sufficiently low viscosity to be used as it is. Examples of the solvent include water, paint thinner, ethanol, isopropyl alcohol, n-butyl alcohol, ethyl acetate, propyl acetate, isobutyl acetate, butyl acetate, methyl ethyl ketone, methyl isobutyl ketone, propylene glycol monomethyl ether, propylene glycol monomethyl ether acetate, toluene, xylene, acetone, cellosolves, glycol ethers, ether, hexane, cyclohexane, 1-butanol, methyl cycl ohexane, ethyl cycl ohexane, isohexane, benzyl alcohol, 2-ethyl-1-hexanol, butyl cellosolve, 1-butoxy-2-propanol, neopentane, solvesso, trichloroethylene, perchloroethylene, methanol, cellosolve acetate, mineral spirit, tetrahydrofuran, dioxane, N-methyl-2-pyrrolidone, and ethyl lactate. These solvents may be used alone or in combination of two or more kinds thereof.

The light-shielding paint preferably has the viscosity of 10 mPas or more and 10,000 mPas or less, and more preferably has the viscosity of 30 mPas or more and 500 mPa·s or less. When the light-shielding paint has the viscosity of less than 10 mPa·s, the film thickness after application of the paint may partially become thin. When the light-shielding paint has the viscosity of more than 10,000 mPas, coating property of the light-shielding paint may become insufficient.

(Colorant)

The light-shielding paint of the present disclosure may contain a colorant. Any material may be used as the colorant as long as the material can color the object black. Examples of the colorant include a dye and a pigment, and the colorant may be used alone or in combination of two or more kinds thereof.

Examples of the dye include an azo pigment, a quinone-based pigment, a cyanine-based pigment, a cation-based pigment, a phthalocyanine-based pigment, an indigo-based pigment, and a fulgide-based pigment. A dye having any color tone can be used and examples of the color tone include black-base, brown-base, yellow-base, red-base, blue-base, and green-base. These dyes may be used alone or in combination of two or more kinds thereof.

Examples of the pigment include carbon black, titanium black, and iron-chromium. Examples of the carbon black include #2650 (Mitsubishi Chemical Corporation), #2600 (Mitsubishi Chemical Corporation), #2350 (Mitsubishi Chemical Corporation), #2300 (Mitsubishi Chemical Corporation), #1000 (Mitsubishi Chemical Corporation), #980 (Mitsubishi Chemical Corporation), #970 (Mitsubishi Chemical Corporation), #960 (Mitsubishi Chemical Corporation), #950 (Mitsubishi Chemical Corporation), #850 (Mitsubishi Chemical Corporation), MCF88 (Mitsubishi Chemical Corporation), MA600 (Mitsubishi Chemical Corporation), #750B (Mitsubishi Chemical Corporation), #650B (Mitsubishi Chemical Corporation), MA100 (Mitsubishi Chemical Corporation), and MA220 (Mitsubishi Chemical Corporation).

The shape of the pigment may be any shape. Examples of the shape of the pigment include a spherical shape, an amorphous shape, a plate-like shape, a needle-like shape, a star-like shape, a chain-like shape, and a multi-layered structure in which plate-like particles are laminated. The pigment in the present disclosure may be coated with another material. The pigment is contained in the paint in the state of aggregates, and the average particle diameter of the aggregates of the pigment is preferably 1 nm or more and 200 nm or less, and more preferably 5 nm or more and 50 nm or less. When the average particle diameter of the aggregates of the pigment is less than 1 nm, the paint may thicken. When the average particle diameter of the aggregates of the pigment is more than 200 nm, scattered light on the film may increase. The average particle diameter of the aggregates of the pigment can be measured by the same method as the average particle diameter of the aggregates of the inorganic particles.

The content of the colorant is preferably 0.5 mass % or more and 50 mass % or less, more preferably 1 mass % or more and 30 mass % or less with respect to the non-volatile content (solid content). When the content of the colorant is less than 0.5 mass %, the light reaching the film may not be fully absorbed and anti-internal reflection performance of the light-shielding film may become insufficient. When the content of the colorant is more than 50 mass %, the film may become too hard.

(Other Additives)

The light-shielding paint may contain any other additive to the extent that the properties of the paint does not deteriorate.

Examples of the additive include a dispersant, an antifoaming agent, a thixotropy imparting agent, a leveling agent, a matting agent, an antiseptic, an antimicrobial, an antifungal agent, an ultraviolet absorber, an ultraviolet photoinitiator, an antioxidant, a coupling agent, and as other than those mentioned above, inorganic fine particles and organic fine particles for adjusting the color tone.

<<Producing Method>>

As the method of producing the light-shielding paint according to the present disclosure, any method can be used as long as the inorganic particles can be dispersed in the light-shielding paint. When the pigment is added to the paint, the pigment is preferably dispersed therein. Examples of the method of producing the light-shielding paint include a method involving using a bead mill, a ball mill, a jet mill, a triple roll mill, a planetary rotation apparatus, a mixer, an ultrasonic disperser, a homogenizer, or the like.

[Light-Shielding Film]

The light-shielding film of the present disclosure is a light-shielding film of black color containing at least a resin, an inorganic particle and an organic particle, wherein the organic particle is a core-shell particle which has a surface layer portion and a center portion, and the elastic modulus of the surface layer portion is higher than the elastic modulus of the center portion. The elastic modulus, the material composition and the producing method of the light-shielding film of the present disclosure will be described below.

<<Elastic Modulus of Light-Shielding Film>>

In recent years, the joining portion of the cemented lens or the lens edge surface has become thinner and soft glass has increasingly used for the lens. Accordingly, when the light-shielding film is formed on the outer peripheral portion of the lens, the lens tends to be stressed due to the light-shielding film. In addition, the lens is often used in situations where large thermal shock is applied, such as in a cold-temperature or scorching-temperature environment. Therefore, it is required to reduce stress on the lens caused by the light-shielding film. A cold-temperature environment herein is assumed to be an environment at about −30° C.

Further, it is preferable that the lens is cleaned by ultrasonic waves multiple times after forming a light-shielding film in order to remove dirt adhered to the lens generated in the manufacturing process of the lens. The ultrasonic cleaning is carried out at normal temperature of about 20° C. The light-shielding film is required to have washability without causing peeling at the interface with the lens due to ultrasonic vibration during cleaning.

Thus, the light-shielding film is required to have film properties of not being peeled off during cleaning process in the manufacturing process of the lens (i.e. washability) and not causing stress that affects the lens even when exposed to temperature changes (i.e. thermal shock resistance), and specifically, required to have the appropriate elastic modulus.

From the viewpoint of thermal shock resistance in a cold-temperature environment, the light-shielding film preferably has the elastic modulus at −30° C. of 2,500 MPa or more and less than 4,100 MPa, more preferably has the elastic modulus at −30° C. of 2,500 MPa or more and 3,800 MPa or less, and even more preferably has the elastic modulus at −30° C. of 3,000 MPa or more and 3,500 MPa or less. When the light-shielding film has the elastic modulus at −30° C. of less than 2,500 MPa, the elastic modulus at normal temperature of the light-shielding film becomes low, and washability thereof may become insufficient. When the light-shielding film has the elastic modulus at −30° C. of 4,100 MPa or more, the lens may crack in thermal shock test.

In addition, given that the light-shielding film is subjected to cleaning at normal temperature, the light-shielding film preferably has the elastic modulus at 20° C. of 400 MPa or more and 2,600 MPa or less, more preferably has the elastic modulus at 20° C. of 500 MPa or more and 2,600 MPa or less, and even more preferably has the elastic modulus at 20° C. of 1,000 MPa or more and 2,200 MPa or less.

When the light-shielding film has the elastic modulus at 20° C. of less than 400 MPa, the light-shielding film may become too soft and washability thereof may become insufficient. In addition, when the light-shielding film has the elastic modulus at 20° C. of more than 2,600 MPa, the elastic modulus at −30° C. thereof also increases, and the lens may crack easily in thermal shock test.

The light-shielding film according to the present disclosure is particularly suitable for the cemented lens, but the application thereof is not limited thereto. The light-shielding film can also be suitably used as a light-shielding film for a lens or an optical element other than the cemented lens, or another article. Specifically, the light-shielding film of the present disclosure can be used in the lens barrel of an optical apparatus such as a camera, a video camera, or a broadcasting equipment, or in a camera body, a video camera body, a surveillance camera, a dashboard camera, an observation camera, or the like that may be used outdoors.

<<Material Composition>>

(Resin)

The details of the resin are as described for the light-shielding paint.

The content of the resin is preferably 5 volume % or more and 80 volume % or less, and more preferably 8 volume % or more and 50 volume % or less, with respect to the light-shielding film. When the content of the resin is less than 5 volume %, the light-shielding film may become too hard, resulting in film cracking. When the content of the resin is more than 80 volume %, it may be difficult to increase the refractive index of the film.

(Inorganic Particle)

The details of the inorganic particle are as described above for the light-shielding paint.

The content of the inorganic particle is preferably 1 volume % or more and 40 volume % or less, and more preferably 2 volume % or more and 20 volume % or less, with respect to the light-shielding film. When the content of the inorganic particle is less than 1 volume %, the refractive index of the light-shielding film does not increase significantly, and anti-internal reflection performance of the film may become insufficient. When the content of the inorganic particle is more than 40 volume %, the elastic modulus of the light-shielding film may become too high, and even when the organic particles (core-shell particles) are added, thermal shock resistance of the film may not be improved. The content of the inorganic particle in the light-shielding film can be determined as the ratio of the area occupied by the inorganic particle in a TEM image of an arbitrary cross section of the light-shielding film. In particular, the ratio of the area occupied by the inorganic particle can be calculated for each of the five areas of 5 μm×5 μm, and the average value thereof can be calculated to determine the content of the inorganic particle in the light-shielding film.

(Organic Particle)

The details of the organic particle are as described above for the light-shielding paint.

The content of the organic particle is preferably 1 volume % or more and 50 volume % or less, more preferably 2 volume % or more and 20 volume % or less, with respect to the light-shielding film. When the content of the organic particle is less than 1 volume %, the elastic modulus at a low temperature of the light-shielding film may not sufficiently decrease, and thermal shock resistance thereof may become insufficient. When the content of the organic particle is more than 50 volume %, washability of the light-shielding film may become insufficient. The content of the organic particle in the light-shielding film can also be determined in the same manner as the content of the inorganic particle in the light-shielding film.

(Colorant)

The details of the colorant are as described above for the light-shielding paint.

The content of the colorant is preferably 1 volume % or more and 30 volume % or less, more preferably 2 volume % or more and 20 volume % or less, with respect to the light-shielding film. When the content of the colorant is less than 1 volume %, the light reaching the film may not be fully absorbed and anti-internal reflection performance of the film may become insufficient. In addition, when the content of the colorant is more than 30 volume %, the light-shielding film may become too hard.

(Other Additives)

The light-shielding film may include any other additive. Details of other additives are as described for the light-shielding paint.

<Forming Method>

The light-shielding film of the present disclosure can be formed by applying the light-shielding paint of the present disclosure and curing the paint.

The average thickness of the light-shielding film is preferably 1 μm or more and 150 μm or less, more preferably 2 μm or more and 100 μm or less, and even more preferably 2 μm or more and 30 μm or less. The average thickness refers to the average value of the film thicknesses of freely-selected 5 parts of the film. Any coating method and curing method can be used as long as the light-shielding paint can be applied substantially uniformly.

Examples of the coating method of the light-shielding paint include brush coating, spray coating, dip coating, spin coating, transfer, and inkjet. The light-shielding film may be a single layer coating or a multilayer coating. In addition, the glass surface thereof may be subjected to the dry surface treatment with UV ozone, plasma, excimer, or the like, or may be subjected to the wet surface treatment with a coupling agent or the like.

In addition, the method of curing the light-shielding film may be a method involving leaving the light-shielding film at room temperature or accelerating heating the film by any heat. The method of curing the light-shielding film by applying heat may be a method involving using a heating furnace or a heater, or infrared heating. The curing temperature is preferably from room temperature to 200° C., and more preferably from room temperature to 150° C. In addition, the light-shielding film may be UV cured.

[Optical Element]

The optical element in the present disclosure is, for example, an optical element used in the lens barrel of an optical apparatus such as a camera, a video camera, or a broadcasting equipment, or in an optical apparatus of a camera body, a video camera body, a surveillance camera, a dashboard camera, an observation camera, or the like that may be used outdoors. The optical element in the present disclosure has the light-shielding film of the present disclosure on the surface of a substrate made of glass, plastic or the like. FIG. 1 is a schematic sectional view for illustrating an example of the optical element in the present disclosure. The optical element in FIG. 1 has a light-shielding film 1 formed on a freely-selected part of the outer peripheral portion which is outside the effective optical surface of the lens as the substrate 2. The light-shielding film 1 may be formed on all of the outer peripheral portion of the substrate 2 or a part of the outer peripheral portion of the substrate 2 depending on the intended use.

The shape of the substrate such as a lens may be any shape. For example, the substrate may have a shape including a concave surface, a convex surface or a combination thereof. In addition, the outer peripheral portion thereof may be flat or may have multiple steps or a groove. Further, multiple substrates such as lenses which are joined together can be used. Any material may be used as a component of the substrate such as a lens. Examples of the material include Li₂O, Na₂O, K₂O, MgO, CaO, SrO, BaO, ZnO, Y₂O₃, La₂O₃, Nd₂O₃, Gd₂O₃, B₂O₃, Al₂O₃, TiO₂, ZrO₂, HfO₂, SiO₂, GeO, Nb₂O₅, Ta₂O₅, P₂O₅, Sb₂O₃, WO₃, F₂. The materials used as the component of the substrate may be used alone or in a combination of two or more kinds thereof.

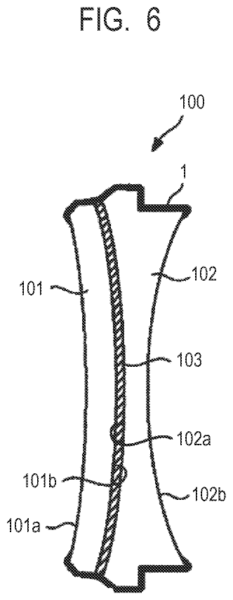

FIG. 6 is a schematic sectional view for illustrating a cemented lens which is an example of the optical element in the present disclosure. The cemented lens 100 in the present disclosure has a first optical element (first optical component) 101, a second optical element (second optical component) 102, and a joining resin layer (third optical component) 103 for joining the first optical element 101 and the second optical element 102. The light-shielding film 1 is provided on the end faces of the first to third optical elements. By use of the light-shielding film 1 of the present disclosure, stress generated when heat is applied can be reduced, and occurrence of a crack in the optical components forming the cemented lens 100 can be suppressed.

As the first optical element 101 and the second optical element 102, one or more kinds of optical glass each having a shape corresponding to the optical characteristics required for the cemented lens 100 can be selected and combined.

As the first optical element 101, any material may be used, but the material having a Young's modulus of 81 GPa or less is preferably used. Since the soft glass having a Young's modulus of 81 GPa or less tends to have a low refractive index, the optical performance can be improved when the soft glass is used in combination with glass having high refractive index (having a Young's modulus of more than 81 GPa). However, the soft glass having a Young's modulus of 81 GPa or less tends to easily crack due to thermal shock, especially when used in combination of two or more pieces of glass having different coefficients of linear expansion, for example, when used for the cemented lens. When the glass having a Young's modulus of 81 GPa or less is used as the first optical element 101 and the light-shielding film 1 of the present disclosure is formed on the outer peripheral portion of the cemented lens 100, cracking due to thermal shock can be prevented. Examples of the glass having a Young's modulus of 81 GPa or less include S-FPL-55 (having a Young's modulus of 69.7 GPa, manufactured by Ohara Inc.), S-FPL51 (having a Young's modulus of 72.7 GPa, manufactured by Ohara Inc.), S-FPM-3 (having a Young's modulus of 80.6 GPa, manufactured by Ohara Inc.), and S-FPM-2 (having a Young's modulus of 75.7 GPa, manufactured by Ohara Inc.), but any glass can be used.

As the second optical element 102, the material having a higher Young's modulus than that of the first optical element 101 is used. As the second optical element 102, any glass having high refractive index can be used, and the glass having a Young's modulus of more than 81 GPa and capable of suppressing cracking of the lens due to thermal shock is preferably used.

The joining resin layer 103 is a layer in which an adhesive used for joining the glass lenses is cured. The adhesive is not only required to be optically transparent but also required to have a high adhesive force and be cured at a high speed. As the adhesive, the acrylic-based, epoxy-based, or polyene-polythiol-based curable adhesive is preferably used. A curing initiator is added to the adhesive, and the adhesive can be cured by heat or ultraviolet rays. However, peeling at the interface or deformation of the surface may occur when the adhesive is cured by heat. Accordingly, it is preferable to use an ultraviolet-curable adhesive as the adhesive for the joining resin layer 103. It is also preferable to use the adhesive containing inorganic fine particles or the like mixed and dispersed therein from the viewpoint of suppressing shrinkage of the adhesive when cured and adjusting the optical properties.

The main surfaces 101a and 101b of the first optical element 101 and the main surfaces 102a and 102b of the second optical element 102 are interfaces with the materials each having the refractive index different from that of each of the optical elements, and are refracting surfaces. When the difference between the refractive indices of the materials in contact with each other at each of these interfaces is large, light reflection occurs, so an anti-reflection film (not shown) may be provided to mitigate the differences between the refractive indices as necessary.

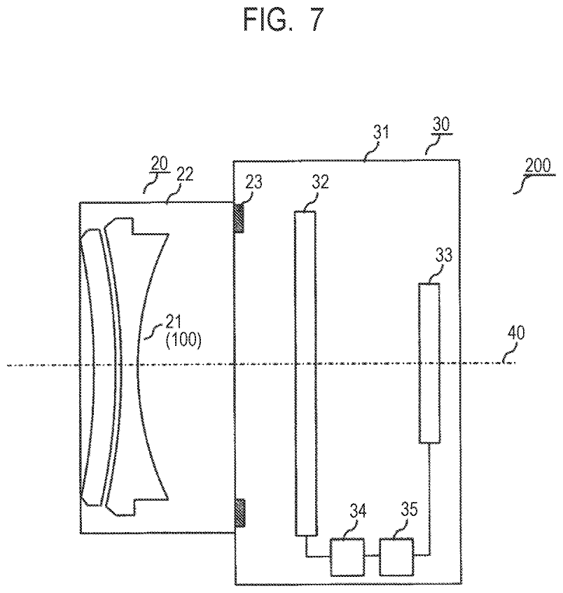

The cemented lens 100 is used as an optical system or a part of an optical system of an optical apparatus such as an image pickup apparatus (including a camera, a video camera, or the like), a telescope, a binocular, a copying machine, a projector or the like. For example, FIG. 7 is a schematic sectional view for illustrating an image pickup apparatus 200 with a lens unit (optical system) 20 mounted on an image pickup unit 30. The cemented lens 21 (100) is provided inside a cylindrical housing 22 of the lens unit 20 and is fixed to the image pickup unit 30 by mounts 23. The image pickup unit 30 is provided with an image pickup element 33 for receiving the light transmitted through the lens unit 20, and a shutter 32, in a housing 31. The image pickup element 33 is arranged so that an optical axis 40 of the cemented lens 21 passes through the center of the image pickup element 33. Further, a driving part 34 for opening and closing the shutter 32 and a control part 35 for controlling the driving part 34, data reading from the image pickup element 33 and the like.

### EXAMPLES

Examples of the present disclosure will be described below.

<Evaluation Method>

(Method of Measuring Average Particle Diameter of Organic Particles)

The average particle diameter of the primary particles of the organic particles was measured with a dynamic light scattering device (Zeta sizer Neo MPT-2: Sysmex Corporation). The organic particles dispersed in a solvent were put in the cell, the measurement at a voltage of 5 mV was performed 20 times and the average value was obtained. The peak value in the number-based particle size distribution was defined as the average particle diameter of the organic particles.

The average particle diameter of the organic particles was evaluated by the following criteria. It can be said that the light-shielding film with the evaluation result of A causes small amount of the scattered light thereon and is excellent. The light-shielding film with the evaluation result B causes the scattered light thereon more than that with the evaluation result A, but is acceptable because the difference between the refractive index of the organic particle and that of the resin is little.
A: The average particle diameter of the organic particles was 200 nm or less.
B: The average particle diameter of the organic particles was more than 200 nm.

<Method of Measuring Elastic Modulus>

A viscoelastic measuring device was used to measure the elastic modulus of the light-shielding film. The size of the light-shielding film was adjusted to 5 mm in width, 20 mm in length, and 0.15 mm in thickness, dried for 1 day, and fired at 40° C. for 100 hours to prepare a sample for the elastic modulus measurement. The prepared sample for the elastic modulus measurement was set in a viscoelastic measuring device, and the elastic modulus at −30° C. and the elastic modulus at 20° C. thereof were measured.

The elastic modulus of the light-shielding film was evaluated by the following criteria. It can be said the light-shielding film with the evaluation result of A has a satisfactory elastic modulus. It can be said that the light-shielding film with the evaluation result of B is a relatively satisfactory light-shielding film. It cannot be said that the light-shielding film with the evaluation result of C is a satisfactory light-shielding film.
A: The light-shielding film had the elastic modulus at −30° C. of 2,500 MPa or more and 3,800 MPa or less, and had the elastic modulus at 20° C. of 500 MPa or more and 2,600 MPa or less.
B: The light-shielding film had the elastic modulus at −30° C. of more than 3,800 MPa and less than 4,100 MPa, or had the elastic modulus at 20° C. of 400 MPa or more and less than 500 MPa.
C: The light-shielding film had the elastic modulus at −30° C. of 4,100 MPa or more, or had the elastic modulus at 20° C. of less than 400 MPa.

<Method of Measuring Ratio of Internal Reflection of the Light>

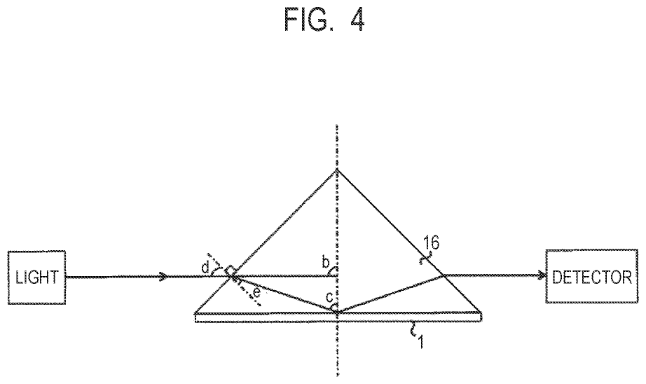

The ratio of the internal reflection of the light of the light-shielding film was measured with a spectrophotometer (U-4100; Hitachi High-Tech Corporation) as illustrated in FIG. 4. A triangular prism 16 was used as the sample for the measurement. The shape of the triangular prism 16 was as follows: the length of one of the two sides of a right angle was 30 mm and the thickness was 10 mm. In addition, the material thereof was S-LAH53 (nd: 1.8; manufactured by Ohara Inc.).

The method of measuring the internal reflection of the light when an angle of incidence ‘b’ of the incident light on the triangular prism 16 is 90° is illustrated in FIG. 4. A light emitted from the spectrophotometer enters the triangular prism 16 at the angle of incidence ‘b’ of 90°. At this time, light refraction occurs due to the difference between the refractive index of air and that of the triangular prism 16. An angle of incidence ‘c’ after the light refraction is 68.13°. An angle ‘e’ after the light refraction with respect to an angle of incidence ‘d’ was calculated using the following formula (1). The angle of incidence ‘c’ was calculated from the angle ‘e’ after the light refraction.

n=sin ‘d’/sin ‘e’ formula (1)

Subsequently, the light refracted at the triangular prism 16 reaches the bottom surface of the triangular prism 16 and is reflected and come out of the triangular prism 16. The intensity of the reflected light is detected by a detector in the visible light region of wavelengths from 400 nm to 700 nm. As the background, a sample in which 3 surfaces: the bottom surface, the surface on which light entered, and the surface from which light was emitted were mirror surfaces and nothing was applied to the bottom surface of the triangular prism 16 was used, and the ratio of the internal reflection of the light was measured when the light-shielding film 1 was formed on the bottom surface of the triangular prism 16 in which 3 surfaces: the bottom surface, the surface on which light entered, and the surface from which light was emitted were mirror surfaces. As the ratio of the internal reflection of the light, the internal reflection of visible light from 400 nm to 700 nm was measured at 1 nm intervals, and the average value of the results was determined.

The ratio of the internal reflection of the light of the light-shielding film was evaluated by the following criteria. It can be said the light-shielding film with the evaluation result of A is the satisfactory film, the light-shielding film with the evaluation result of B has a slightly inferior ratio of the internal reflection of the light but is acceptable, and the light-shielding film with the evaluation result of C is the film with poor optical properties.
A: The ratio of the internal reflection of the light was less than 40%.
B: The ratio of the internal reflection of the light was 40% or more and less than 60%.
C: The ratio of the internal reflection of the light was 60% or more.

<Evaluation Method of Thermal Shock Resistance>

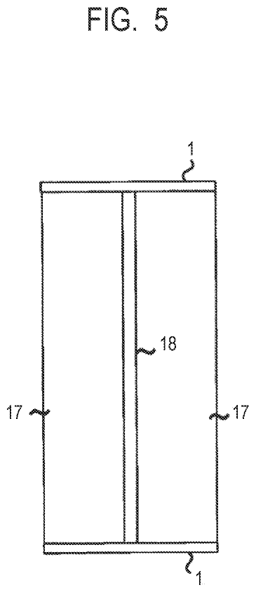

FIG. 5 is a schematic sectional view for illustrating the test piece used for the evaluation of thermal shock resistance of the light-shielding film. For the evaluation of thermal shock resistance of the light-shielding film, as illustrated in FIG. 5, a test piece in which two pieces of circular monitor glass 17 were joined together with an adhesive 18, and a light-shielding film 1 was formed on the surface of the outer peripheral portion thereof so that the thickness of the light-shielding film 1 was about 4 μm was used. The shape of each of the two pieces of circular monitor glass 17 was 100 mm in diameter and 10 mm in thickness, and the surface of the outer peripheral portion was frosted with #1200. The materials of the two pieces of circular monitor glass 17 were S-LAH53 (nd: 1.8; having a Young's modulus of 112.7 GPa; manufactured by Ohara Inc.) and S-FPL55 (nd:1.4; having a Young's modulus of 69.8 GPa; manufactured by Ohara Inc.), respectively. In Example 15, S-BSM28 (nd:1.6; having a Young's modulus of 85.3 GPa; manufactured by Ohara Inc.) was used instead of S-FPL55.

The prepared test piece was left in an environment at −50° C. for 30 minutes, then left in an environment at 60° C. for 30 minutes. This was repeated 10 times to apply thermal shock to the test piece.

Thermal shock resistance of the light-shielding film was evaluated by the following criteria. It can be said the light-shielding film with the evaluation result of A has acceptable thermal shock resistance, and the light-shielding film with the evaluation result of B is the film having a problem with thermal shock resistance.
A: No change occurred in glass.
B: Glass cracked or poor appearance was exhibited.

<Evaluation Method of Washability>

For the evaluation of washability of the light-shielding film, the test piece similar to that for thermal shock resistance was used. The prepared test piece was placed in water, subjected to ultrasonic cleaning for 5 minutes, and dried. This was repeated 5 times as ultrasonic cleaning.

Washability of the light-shielding film was evaluated by the following criteria. It can be said the light-shielding film with the evaluation result of A is acceptable, the light-shielding film with the evaluation result of B exhibits a color change in the lens interior view but acceptable, and the light-shielding film with the evaluation result of C is the film having a problem with washability.
A: Neither peeling nor color change in the lens interior view occurred.
B: No peeling occurred, but a color change in the lens interior view occurred.
C: Peeling occurred.

<Evaluation of Color>

For the evaluation of the color of the light-shielding film, a test piece having the light-shielding film 1 with a thickness of about 20 μm formed on a freely-selected glass substrate was used. The lightness L* of the color of the prepared test piece was measured with a color difference meter and evaluated by the following criteria. It can be said the light-shielding film with the evaluation result of A is the film with a high degree of blackness, the light-shielding film with the evaluation result of B is the film of black color, and it cannot be said the light-shielding film with the evaluation result of C is the film of black color.
A: L* was less than 5.
B: L* was 5 or more and less than 14.
C: L* was 14 or more.

<Measurement of Average Particle Diameter of Aggregates of Inorganic Particles>

The average particle diameter of the aggregates of the inorganic particles was measured by a transmission electron microscopy (TEM). A cross section of the prepared light-shielding film was cut out and an image thereof was obtained with TEM. The image was analyzed by Image J to calculate the particle size distribution. To measure the particle diameter, 10 or more particles (aggregates) were placed in the evaluation screen, and the average diameter thereof was calculated. When the average particle diameter is 250 nm or less, it can be said that the light-shielding film causes small amount of the scattered light thereon and is excellent. When the average particle diameter is more than 250 nm, it can be said that the light-shielding film causes large amount of the scattered light thereon and is not excellent.

<Material>

(1) Resin
Bisphenol A-type epoxy resin (jER 828; Mitsubishi Chemical Corporation)

(2) Colorant
A: Carbon black
B: Green-based dye (VALIFAST GREEN 1501; Orient Chemical Industries Co., Ltd.)

(3) Inorganic Particles

TABLE 1

| | | | d-Line |
|---|---|---|---|
| | | | refractive |
| | Inorganic particles | Trade name | index |
| A | Rutile-type titanium | — | 2.72 |
| | oxide | | |
| B | Iron oxide | TM Red 8270 (Dainichiseika Color | 3.01 |
| | | & Chemicals Mfg. Co., Ltd.) | |
| C | Zirconia | ZIRCOSTAR-ZP-153 | 2.05 |
| | | (Nippon Shokubai Co., Ltd.) | |
| D | Aluminium oxide | Al-L7 (Taki Chemical Co., Ltd.) | 1.76 |

(4) Organic Particles

TABLE 2

| | | Surface | | Average |
|---|---|---|---|---|
| | | layer | | particle |
| | Trade name | portion | Center portion | diameter (nm) |
| A | MX-153 | Acrylic | Butadiene rubber | 100 |
| | (Kaneka Corporation) | | | |
| B | — | Acrylic | Butadiene rubber | 50 |
| C | MX-257 | Acrylic | Butadiene rubber | 200 |
| | (Kaneka Corporation) | | | |
| D | METABLEN S-2001 | Acrylic | Silicone rubber | 200-300 |
| | (Mitsubishi Chemical | | | |
| | Corporation) | | | |
| E | NALSTAR-SR-110 | — | Styrene-butadiene | 110 |
| | (Nippon A&L Inc.) | | rubber | |

The average particle diameter of the organic particles in the light-shielding paint or the light-shielding film becomes substantially the same value as that shown in Table 2. The organic particles A to E were mixed in the epoxy resin (bisphenol A-type epoxy resin) at a mass ratio of ⅓. The organic particles E were single layer particles each having no surface layer portion, each having the center portion of a styrene-butadiene rubber, and having an average particle diameter of 110 nm.

(5) Coupling Agent
Epoxy-based silane coupling agent (KBM 403; Shin-Etsu Chemical Co., Ltd.)

(6) Dispersant
DISPERBYK2155 (BYK Japan KK.)

(7) Curing Agent
Amine-based curing agent

(8) Curing Agent Accelerator
A: N, N-dimethylbenzylamine
B: Salicylic acid
C: 2,4,6-Tris (dimethylamino) phenol

### Example 1

1. Adjustment of a Resin Composition for the Light-Shielding Paint

The following materials were weighed: 100 g of an epoxy resin; 50 g of the colorant A; 200 g of the inorganic particles A; 300 g of the organic particles A (including 200 g of an epoxy resin); 20 g of the coupling agent; 60 g of the dispersant; and 400 g of the solvent (toluene). All the materials were placed in a container and stirred with a stirring blade for 20 minutes to obtain a pre-dispersion liquid. The pre-dispersion liquid was stirred with a bead mill for 180 minutes to obtain a resin composition for the light-shielding paint.

2. Preparation of the Light-Shielding Film

As shown in Table 3, 150 g of the curing agent and 2 g of the curing agent accelerator A were added to the total amount of the obtained resin composition for the light-shielding paint, and the mixture was stirred with a roll coater for 30 minutes. The obtained mixed liquid (light-shielding paint) of the resin composition for the light-shielding paint, the curing agent and the like was applied to the glass product or the lens for the evaluation at a predetermined thickness and dried at room temperature for 60 minutes. After drying the film, the film was cured in a constant temperature furnace at 40° C. for 8 hours to obtain a light-shielding film.

In Tables 3 and 4, the content of the resin including the resin which was mixed with the organic particles is shown in a parenthesis in the column of the resin, and the content of the organic particles excluding the resin which was mixed with the organic particles is shown in a parenthesis in the column of the organic particles.

<Examples 2 to 14, Comparative Examples 1 to 3>

Light-shielding films were each prepared and evaluated in the same manner as in Example 1 except for the materials thereof and conditions under which each of the light-shielding film was prepared were changed to that listed in Tables 3 and 4. The evaluation results are shown in Tables 3 and 4.

TABLE 3

| | | | Example | | | | | | | | | |
|---|---|---|---|---|---|---|---|---|---|---|---|---|
| | | | 1 | 2 | 3 | 4 | 5 | 6 | 7 | 8 | 9 | 10 |
| Composition | Resin | Content | 100 | 100 | 100 | 100 | 100 | 100 | 100 | 100 | 100 | 100 |
| | | [g] | (300) | (300) | (300) | (300) | (366.6) | (233.4) | (380) | (220) | (300) | (300) |
| | Colorant | Material | A | A | A | A | A | A | A | A | A | A |
| | | Content | 50 | 50 | 50 | 50 | 50 | 50 | 50 | 50 | 50 | 50 |
| | | [g] | | | | | | | | | | |
| | Inorganic | Material | A | A | A | A | A | A | A | A | B | C |
| | Particles | Content | 200 | 200 | 200 | 200 | 200 | 200 | 200 | 200 | 200 | 200 |
| | | [g] | | | | | | | | | | |
| | Organic | Material | A | B | C | D | A | A | A | A | A | A |
| | Particles | Content | 300 | 300 | 300 | 300 | 400 | 200 | 420 | 180 | 300 | 300 |
| | | [g] | (100) | (100) | (100) | (100) | (133.3) | (66.7) | (140) | (60) | (100) | (100) |
| | Coupling | Content | 20 | 10 | 10 | 10 | 10 | 10 | 10 | 10 | 10 | 10 |
| | agent | [g] | | | | | | | | | | |
| | Dispersant | Content | 60 | 50 | 50 | 50 | 50 | 50 | 50 | 50 | 50 | 50 |
| | | [g] | | | | | | | | | | |
| | Solvent | Content | 400 | 700 | 700 | 700 | 700 | 700 | 700 | 700 | 700 | 700 |
| | | [g] | | | | | | | | | | |
| | Curing | Content | 150 | 150 | 150 | 150 | 150 | 150 | 150 | 150 | 150 | 150 |
| | agent | [g] | | | | | | | | | | |
| | Curing | Material | A | A | A | A | A | A | A | A | A | A |
| | agent | Content | 2 | 2 | 2 | 2 | 2 | 2 | 2 | 2 | 2 | 2 |
| | accelerator | [g] | | | | | | | | | | |
| Evaluation | Average particle | | A | A | A | B | A | A | A | A | A | A |
| | diameter of organic | | | | | | | | | | | |
| | particles | | | | | | | | | | | |
| | Elastic | −30° C. | 3200 | 3200 | 3200 | 3200 | 2500 | 3800 | 2400 | 4000 | 3200 | 3200 |
| | modulus | [MPa] | | | | | | | | | | |
| | | 20° C. | 1100 | 1100 | 1100 | 1100 | 500 | 2600 | 400 | 2800 | 1100 | 1100 |
| | | [MPa] | | | | | | | | | | |
| | | Evaluation | A | A | A | A | A | A | B | B | A | A |

| | | | | | | | | | | |
|---|---|---|---|---|---|---|---|---|---|---|
| Rario of internal | A | A | A | A | A | A | B | A | A | A |
| reflection of light | | | | | | | | | | |
| Thermal shock | A | A | A | A | A | A | A | A | A | A |
| resistance | | | | | | | | | | |
| Washability | A | A | A | A | A | A | B | A | A | A |
| Color | A | A | A | A | A | A | A | A | A | A |
| Average particle | 120 | 120 | 120 | 120 | 120 | 120 | 120 | 120 | 140 | 160 |
| diameter of inorganic | | | | | | | | | | |
| particles [nm] | | | | | | | | | | |

TABLE 4

| | | | Example | | | | | Comparative Example | | |
|---|---|---|---|---|---|---|---|---|---|---|
| | | | 11 | 12 | 13 | 14 | 15 | 1 | 2 | 3 |
| Composition | Resin | Content | 100 (300) | 100 (300) | 100 (300) | 100 (300) | 100 (300) | 100 (300) | 100 (300) | 100 |
| | | [g] | | | | | | | | |
| | Colorant | Material | A | A | A | A | A | A | B | A |
| | | Content | 50 | 50 | 50 | 50 | 50 | 50 | 50 | 50 |
| | | [g] | | | | | | | | |
| | Inorganic | Material | D | A | A | A | A | A | A | A |
| | Particles | Content | 200 | 200 | 200 | 200 | 200 | 100 | 100 | 200 |
| | | [g] | | | | | | | | |
| | Organic | Material | A | A | A | A | A | E | A | No |
| | Particles | Content | 300 (100) | 300 (100) | 300 (100) | 300 (100) | 300 (100) | 300 (100) | 300 (100) | 0 |
| | | [g] | | | | | | | | |
| | Coupling | Content | 10 | 10 | 10 | 10 | 20 | 20 | 20 | 20 |
| | agent | [g] | | | | | | | | |
| | Dispersant | Content | 50 | 50 | 50 | 50 | 60 | 60 | 60 | 60 |
| | | [g] | | | | | | | | |
| | Solvent | Content | 700 | 700 | 700 | 700 | 400 | 400 | 400 | 400 |
| | | [g] | | | | | | | | |
| | Curing agent | Content | 150 | 150 | 150 | 150 | 150 | 150 | 150 | 150 |
| | | [g] | | | | | | | | |
| | Curing agent | Material | A | No | B | C | A | A | A | A |
| | accelerator | Content | 2 | 0 | 2 | 2 | 2 | 2 | 2 | 2 |
| | | [g] | | | | | | | | |
| Evaluation | Average particle diameter of | | A | A | A | A | A | A | A | A |
| | organic particles | | | | | | | | | |
| | Elastic | −30° C. | 3200 | 3200 | 3200 | 3200 | 3200 | 3200 | 3200 | 4300 |
| | modulus | [MPa] | | | | | | | | |
| | | 20° C. | 1100 | 1100 | 1100 | 1100 | 1100 | 1100 | 1100 | 3500 |
| | | [MPa] | | | | | | | | |
| | | Evaluation | A | A | A | A | A | A | A | C |

| | | | | | | | | |
|---|---|---|---|---|---|---|---|---|
| Ratio of internal reflection of | B | A | A | A | A | A | B | A |
| light | | | | | | | | |
| Thermal shock resistance | A | A | A | A | A | A | A | B |
| Washability | A | B | A | A | A | C | A | A |
| Color | A | A | A | A | A | A | C | A |
| Average particle diameter of | 85 | 120 | 120 | 120 | 120 | 120 | 120 | 120 |
| inorganic particles [nm] | | | | | | | | |

As shown in Tables 3 and 4, the average particle diameters of the organic particles in Examples 1 to 15 were excellent. In addition, each of the light-shielding films of Examples 1 to 15 had the elastic modulus at −30° C. of less than 4,100 MPa and the elastic modulus at 20° C. of 400 MPa or more, which was excellent. Further, each of the light-shielding films of Examples 1 to 15 had the ratio of the internal reflection of the light of less than 60%, which was excellent. In addition, each of the light-shielding films of Examples 1 to 15 had excellent thermal shock resistance without causing any change such as cracking or peeling in appearance thereof. Further, each of the light-shielding films of Examples 1 to 15 had excellent washability without causing peeling. In addition, the L* values of the colors of the light-shielding films of Examples 1 to 15 were each less than 5, and the films could be evaluated as excellent films.

In Comparative Example 1, the organic particles E each having no surface layer portion were used as the organic particles, which differs from Example 1, the light-shielding film had a problem with washability and caused peeling.

In Comparative Example 2, the colorant B of a green dye was used as the colorant, which differs from Example 1, and the ratio of the internal reflection of the light of the light-shielding film was 60% or more, which was unacceptable. In addition, the L* value of the color of the light-shielding film of Comparative Example 2 was 10 or more and the color thereof was not of black color and of green color, which was also unacceptable.

In Comparative Example 3, no organic particles were added, which differs from Example 1, the light-shielding film had the elastic modulus at −30° C. of 4,300 MPa and the elastic modulus at 20° C. of 3,500 MPa, and the film became hard. In addition, the light-shielding film caused cracking and had a problem with thermal shock resistance.

According to the present disclosure, it is possible to provide a light-shielding film which prevents cracking of the lens even when the lens configuration is easily subjected to stress and the lens is exposed to severe thermal shock, has high washability, and has high anti-internal reflection performance. In addition, according to the present disclosure, it is possible to provide an optical element having the light-shielding film, and a light-shielding paint.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-174688, filed Oct. 31, 2022, which is hereby incorporated by reference herein in its entirety.

What is claimed is:

1. A light-shielding film comprising a resin, an inorganic particle and an organic particle,
wherein the organic particle is a core-shell particle which has a surface layer portion and a center portion, and an elastic modulus of the surface layer portion is higher than an elastic modulus of the center portion.

2. The light-shielding film according to claim 1, wherein the center portion comprises rubber.

3. The light-shielding film according to claim 1,
wherein the surface layer portion comprises any one selected from the group consisting of: an epoxy resin; an acrylic resin; a urethane resin; an acrylic urethane resin; a phenol resin; a melamine resin; a polyester resin; an alkyd resin; a polyimide resin; and combination therefrom.

4. The light-shielding film according to claim 1, wherein the light-shielding film has an elastic modulus at −30° C. of 2,500 MPa or more and 3,800 MPa or less and an elastic modulus at 20° C. of 500 MPa or more and 2,600 MPa or less.

5. The light-shielding film according to claim 1, wherein the core-shell particle has an average particle diameter of 50 nm or more and 200 nm or less.

6. The light-shielding film according to claim 1, further comprising a colorant.

7. Alight-shielding paint comprising a resin, an inorganic particle and an organic particle,
wherein the organic particle is a core-shell particle which has a surface layer portion and a center portion, and an elastic modulus of the surface layer portion is higher than an elastic modulus of the center portion.

8. The light-shielding paint according to claim 7, wherein the center portion comprises rubber.

9. The light-shielding paint according to claim 7,
wherein the surface layer portion comprises any one selected from the group consisting of: an epoxy resin; an acrylic resin; a urethane resin; an acrylic urethane resin; a phenol resin; a melamine resin; a polyester resin; an alkyd resin; a polyimide resin; and combination therefrom.

10. The light-shielding paint according to claim 7, further comprising a curing agent and a curing agent accelerator.

11. The light-shielding paint according to claim 10, wherein the curing agent accelerator comprises any one selected from the group consisting of: N; N-dimethylbenzylamine; salicylic acid; 2,4,6-tris (dimethylamino) phenol; and combinations therefrom.

12. The light-shielding paint according to claim 7, wherein a cured film obtained by curing the light-shielding paint has an elastic modulus at −30° C. of 2,500 MPa or more and 3,800 MPa or less and an elastic modulus at 20° C. of 500 MPa or more and 2,600 MPa or less.

13. The light-shielding paint according to claim 7, wherein the core-shell particle has an average particle diameter of 50 nm or more and 200 nm or less.

14. A light-shielding paint comprising a mixture of an agent A of black color containing at least an inorganic particle and a solvent, an agent B containing at least a resin and an organic particle, and an agent C containing at least a curing agent and a curing agent accelerator,
wherein the organic particle is a core-shell particle which has a surface layer portion and a center portion, and an elastic modulus of the surface layer portion is higher than an elastic modulus of the center portion.

15. The light-shielding paint according to claim 14, wherein the agent A further comprises a colorant.
